(19) United States
(12) Patent Application Publication
(10) Pub. No.: US 2025/0006043 A1
(43) Pub. Date: Jan. 2, 2025

(54) Wearable Device for Wireless Control of External Systems

(71) Applicant: Faisal Alothainah, Qurain (KW)

(72) Inventor: Faisal Alothainah, Qurain (KW)

(21) Appl. No.: 18/802,053

(22) Filed: Aug. 13, 2024

(51) Int. Cl. G08C 17/02; G06F 1/16; G06F 3/01; H04W 4/80

(52) U.S. Cl. CPC G08C 17/02; G06F 1/163; G06F 3/017; H04W 4/80

(57) ABSTRACT

An invention is disclosed for a wearable device designed to wirelessly control an external system, such as a computer running presentation software. The device comprises a wearable unit worn on the user's wrist, which includes a power source, a control module, and a wireless communication module. At least one sensor, connected to the control module, detects finger movements and generates corresponding control signals. These signals are transmitted wirelessly to the external system. The device allows for hands-free operation during presentations, enhancing the user's mobility and natural gesturing. The wearable unit is connected to the sensors via flexible wires, and the device is capable of distinguishing between intentional and unintentional movements.

### FIELD OF INVENTION

The present invention relates generally to wearable devices, specifically those designed for wirelessly hands-free control of external systems, such as computers or presentation software, through the detection of finger movements.

### BACKGROUND

In the realm of modern presentations, the effectiveness of communication is paramount. Presenters rely heavily on various tools to enhance their delivery, with one of the most common devices being the wireless presenter, also known as a clicker. This device allows the presenter to control the flow of slides, facilitating a smooth and uninterrupted presentation. However, the traditional wireless presenter, while widely used, imposes certain limitations that can impede the natural flow of a presentation. These limitations stem from the necessity of physically holding the device, which restricts the presenter's ability to use both hands freely, consequently affecting their ability to engage fully with the audience through gestures and other non-verbal communication cues.

The reliance on a handheld clicker can disrupt the fluidity of a presentation, particularly for presenters who naturally use both hands for gesturing. Effective presentation delivery often involves the use of hand gestures to emphasize points, engage the audience, and convey enthusiasm. However, when one hand is occupied with a clicker, the range of expressive gestures is significantly limited, which can reduce the overall impact of the presentation. This limitation is especially pronounced in dynamic presentations where the speaker's physical movement and hand gestures are integral to the delivery.

Moreover, the requirement to focus on operating the clicker can distract the presenter, dividing their attention between managing the device and delivering the content. This distraction can lead to a disjointed presentation, where the speaker's engagement with the audience is compromised. The cognitive load associated with operating the clicker, albeit minor, can accumulate, particularly in high-stakes presentations, leading to a decrease in the overall effectiveness of the communication. Presenters often aspire to maintain a seamless connection with their audience, and the need to constantly manage a handheld device can hinder this objective.

Another drawback of the traditional wireless presenter is its impact on the presenter's mobility. When a presenter is confined to holding a clicker, their movement across the stage may become less fluid, as they must balance the need to operate the device with the desire to move naturally. This can be particularly challenging in large venues or in presentations where the speaker needs to interact with the audience across a wide area. The physical constraint of holding a device can lead to less dynamic presentations, where the presenter is more stationary than they might otherwise be, thereby limiting their ability to fully engage the audience.

In addition to these functional limitations, traditional wireless presenters are often not adaptable to the varying needs of different users. Presenters with disabilities or those who may have difficulty using one hand for extended periods may find these devices cumbersome and challenging to use effectively. The one-size-fits-all design of many clickers does not account for the diverse needs of all presenters, which can result in a less inclusive experience. This lack of adaptability highlights a significant gap in the current market for presentation tools, where a more versatile solution could greatly enhance the usability for a broader range of presenters.

Furthermore, the evolution of presentation technology has outpaced the design of traditional clickers. As presentations become more interactive and complex, with multiple media types and the need for real-time adjustments, the limitations of a simple, handheld device become more apparent. The need for a device that can seamlessly integrate with modern presentation software, while also allowing the presenter to maintain full control without physical constraints, has become increasingly evident. The current generation of clickers fails to address these evolving needs, leading to a growing demand for a more advanced solution that can cater to the dynamic requirements of contemporary presentations.

It is within this context that the present invention is provided.

### SUMMARY

The present invention relates to a device for wirelessly controlling an external system, specifically designed for use during presentations. The invention comprises a wearable unit configured to be worn on the user's wrist, equipped with a power source, a control module, and a wireless communication module. The device further includes at least one sensor that detects movement of the user's fingers, with the sensor operatively connected to the control module via a connecting element. The control module processes the detected movements to generate control signals, which are then transmitted wirelessly to the external system to control various functions.

The invention offers several advantages, including the ability to control presentations without the need to hold a traditional clicker, thereby allowing the user to maintain natural hand gestures during the presentation. The wearable nature of the device enhances the presenter's mobility, as the user can move freely without being constrained by handheld devices. The use of wireless communication further supports seamless interaction with external systems, ensuring that the control signals are transmitted efficiently and without interference.

In some embodiments, the device includes two sensors, one attached to the ring finger and the other to the middle finger of the user's hand. This configuration allows the user to control different functions, such as advancing or reversing slides in a presentation, through simple bending motions of the fingers. This setup provides a more intuitive and natural way to control presentations.

In further embodiments, the control module is configured to distinguish between intentional and unintentional finger movements by applying a predetermined threshold. This feature helps to prevent accidental commands, ensuring that only deliberate gestures result in control signals being generated and transmitted.

In yet further embodiments, the connecting element comprises a flexible wire extending from the wearable unit to the sensor. This wire is designed to be both durable and flexible, allowing for comfortable and unobtrusive wear while maintaining reliable connectivity between the sensor and the wearable unit.

In additional embodiments, the wearable unit is made from a stretchable material and includes an adjustable strap. This design accommodates users with varying wrist sizes and ensures that the device fits securely and comfortably on the user's wrist.

In some embodiments, the wireless communication module employs Bluetooth Low Energy (BLE) technology, which is optimized for low-power consumption and stable connectivity. This choice of communication protocol ensures that the device can maintain a reliable connection with the external system over a typical presentation distance while conserving battery life.

In further embodiments, the wearable unit includes a rechargeable battery, which can be recharged via a USB-C port. This feature provides convenience to the user by allowing for easy recharging and extending the usability of the device between charges.

In yet further embodiments, the control module includes a power management system that conserves battery life by automatically entering a low-power mode when the device is not in active use. This feature helps to prolong the operating time of the device, reducing the need for frequent recharging.

In additional embodiments, the device provides haptic feedback to the user upon successful detection of a valid control signal. This feedback mechanism ensures that the user is aware when their gestures have been recognized and a control signal has been generated.

In some embodiments, the device includes a feedback mechanism, such as an LED indicator or sound emitter, to notify the user of the device's operational status, including battery level and connectivity status. This feature helps the user to monitor the device's status during use, ensuring it functions as intended.

In further embodiments, the control module is configurable to allow user calibration of the sensor sensitivity. This feature enables the device to accommodate different users' preferences or physical characteristics, providing a customized experience for each user.

In yet further embodiments, the external system controlled by the device may include a computer running presentation software. The control signals generated by the device may be configured to navigate between slides in the presentation, offering the user a hands-free method to control their presentations.

### BRIEF DESCRIPTION OF THE DRAWINGS

Various embodiments of the invention are disclosed in the following detailed description and accompanying drawings.

FIG. 1 illustrates an example of the wearable device as worn on a user's hand, showing the placement of sensors and connecting elements.

FIG. 2 illustrates an example of the wearable device in operation, where the user's bent ring finger triggers a command that advances a presentation slide.

FIG. 3 illustrates an example block diagram of the wearable device's components and its wireless connection to an external device, such as a laptop.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The term “wearable unit” refers to any component or assembly designed to be worn on a user's body, particularly on the wrist, to facilitate the operation of the invention. This includes, but is not limited to, devices that encompass a wristband, bracelet, or strap made from materials such as silicone, neoprene, or other stretchable and flexible polymers. In one example implementation, the wearable unit may comprise an adjustable strap with a buckle or hook-and-loop fastener, ensuring a secure fit on a variety of wrist sizes. The wearable unit may also house electronic components such as a control module, power source, and wireless communication module, all encased in a water-resistant and durable enclosure to protect against environmental factors.

The term “control module” refers to any electronic component or system within the wearable unit that processes input signals from sensors and generates output signals for transmission. This includes, but is not limited to, microcontrollers, processors, or integrated circuits capable of executing programmed instructions to interpret sensor data. In one example implementation, the control module may be a microcontroller that interprets analog signals from the sensors, applies filtering algorithms to distinguish intentional gestures from noise, and generates digital control signals for transmission via the wireless communication module.

The term “sensor” refers to any device or component capable of detecting physical movements or gestures of the user and converting these movements into electrical signals. This includes, but is not limited to, pressure sensors, flex sensors, capacitive sensors, resistive sensors, or optical sensors attached to the user's fingers. The sensor is operatively connected to the control module via flexible wiring, ensuring accurate detection of finger movements.

The term “wireless communication module” refers to any component or system that enables the transmission of control signals from the wearable unit to an external system without the use of physical connections. This includes, but is not limited to, Bluetooth, Wi-Fi, or other radio frequency communication protocols. In one example implementation, the wireless communication module may be a Bluetooth Low Energy (BLE) module configured to pair with a computer or presentation system, ensuring low power consumption while maintaining a stable connection over typical presentation distances.

The term “connecting element” refers to any physical link or interface that operatively connects the sensor to the wearable unit, allowing the transmission of signals between these components. This includes, but is not limited to, flexible wires, conductive threads, or printed circuit pathways. In one example implementation, the connecting element may be a flexible insulated wire that runs along the user's hand from the sensor to the wearable unit, designed to withstand repeated flexing and movement without degrading signal integrity.

The term “power source” refers to any component or assembly that provides electrical energy to the wearable unit, enabling its operation. This includes, but is not limited to, rechargeable batteries, single-use batteries, or energy harvesting components. In one example implementation, the power source may be a lithium-ion rechargeable battery integrated within the wearable unit, providing power to the control module and wireless communication module. The battery may be recharged via a USB-C port located on the wearable unit, offering a convenient and widely adopted method of recharging.

### DESCRIPTION OF DRAWINGS

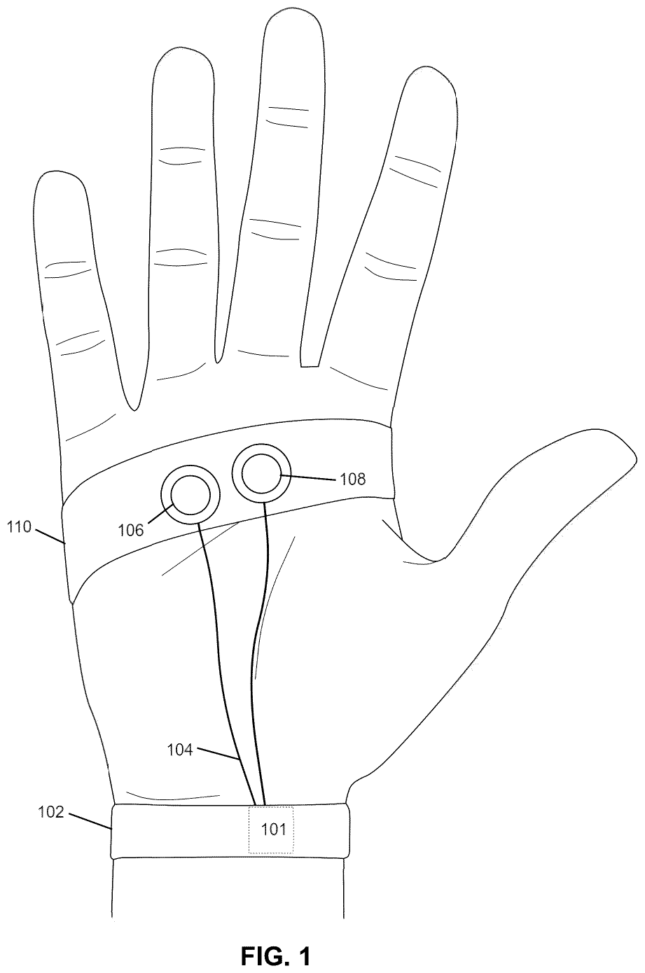

FIG. 1 illustrates a perspective view of an embodiment of the wearable device for wirelessly controlling an external system, as applied to a user's hand. The device comprises a wearable unit 100 designed to be worn on the user's wrist. The wearable unit 100 includes a housing that contains a power source, control module 101, and wireless communication module, all encapsulated within a stretchable and durable material that conforms to various wrist sizes. The wearable unit 100 is secured to the wrist by an adjustable strap 102, which may utilize a buckle or hook-and-loop fastener to ensure a snug fit.

Extending from the wearable unit 100 is a pair of flexible wires 104, which serve as the connecting element between the wearable unit 100 and the sensors 106, 108 positioned on the user's hand. The flexible wire 104 is designed to be lightweight and durable, allowing for free movement of the hand and fingers without causing discomfort or interference. The wire 104 is insulated with a protective sheath to prevent damage from wear and tear during regular use, and it is routed along the side of the hand to minimize obstruction.

The sensors 106, 108 are positioned on the palm side of the hand, specifically at the base of the ring finger and middle finger, respectively. These sensors 106, 108 are configured to detect the pressure exerted by the fingers when they fold over and press against the sensors, generating signals corresponding to the pressure detected. In one implementation, the sensors 106, 108 may be pressure sensors that change resistance based on the amount of force applied, though other types of sensors, such as capacitive or optical sensors, could also be employed. The sensors 106, 108 are securely attached to the fingers using a stretchable strap 110 that wraps around the palm, holding the sensors 106, 108 in place while allowing for flexibility and comfort.

The control module within the wearable unit 100 is configured to interpret the signals received from the sensors 106, 108 via the flexible wire 104. When the user folds and presses the ring finger, the first sensor 106 detects the pressure and sends a corresponding signal to the control module, which then processes the signal and generates a control signal for transmission to the external system. Similarly, when the user folds and presses the middle finger, the second sensor 108 detects the pressure, and the control module processes this signal to generate a different control signal. These control signals are then transmitted wirelessly to the external system via the wireless communication module housed within the wearable unit 100.

The wireless communication module, integrated within the wearable unit 100, may utilize Bluetooth Low Energy (BLE) technology to establish a stable connection with the external system. The BLE module ensures that the control signals generated by the control module are transmitted efficiently, with minimal power consumption, over a typical range suitable for presentations.

Additionally, the wearable unit 100 includes a rechargeable battery, which powers the entire system. The battery is rechargeable via a USB-C port located on the wearable unit 100, allowing for convenient recharging when necessary. The control module may also include a power management system that conserves battery life by entering a low-power mode when the device is not in active use.

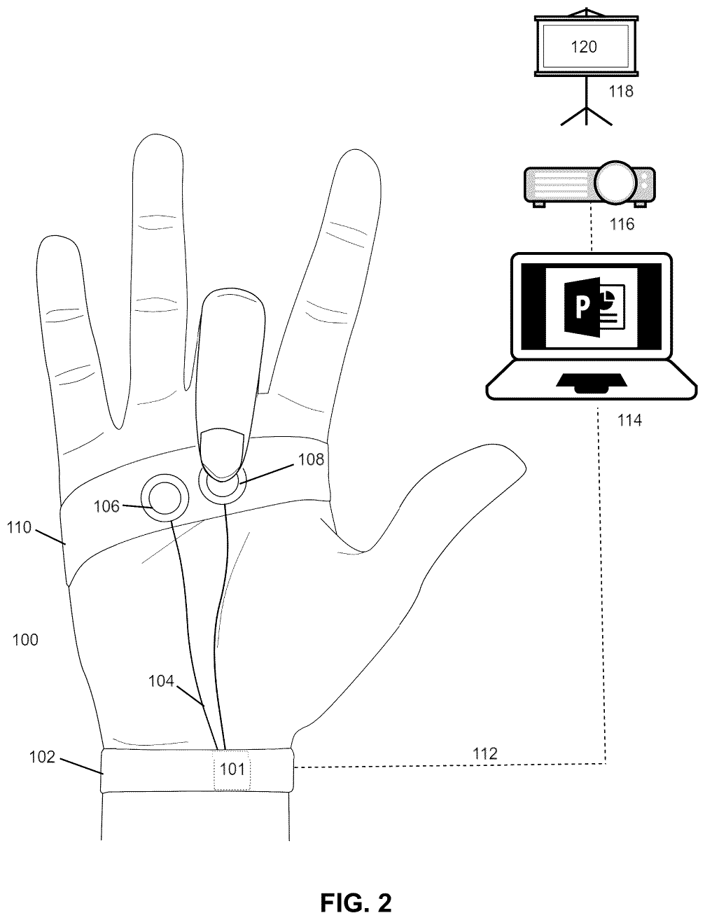

FIG. 2 illustrates the operation of the wearable device depicted in FIG. 1, specifically demonstrating how the device functions when the user bends their ring finger. In this embodiment, the user's ring finger is shown in a bent position, making contact with the first sensor 106 positioned on the palm side of the hand. The bending of the ring finger is detected by the first sensor 106, which is configured to measure the change in resistance or capacitance resulting from the finger's movement.

Upon detecting the bending motion, the first sensor 106 sends a signal through the flexible wire 104 to the control module housed within the wearable unit 100. The control module processes the signal and determines that the specific gesture corresponds to an action command, in this case, advancing to the next slide in a presentation.

The control module then generates a control signal based on this input and transmits it wirelessly via the wireless communication module integrated within the wearable unit 100. As illustrated, this wireless signal 112 is sent to an external device 114, such as a computer running presentation software. The external device 114 receives the control signal and, in response, executes the command to advance the presentation to the subsequent slide.

FIG. 2 further shows that the external device 114 is connected to a projector 116, which projects the presentation onto a screen 118. The projected slide 120 displayed on the screen 118 reflects the change prompted by the user's finger gesture, demonstrating the real-time interaction facilitated by the device.

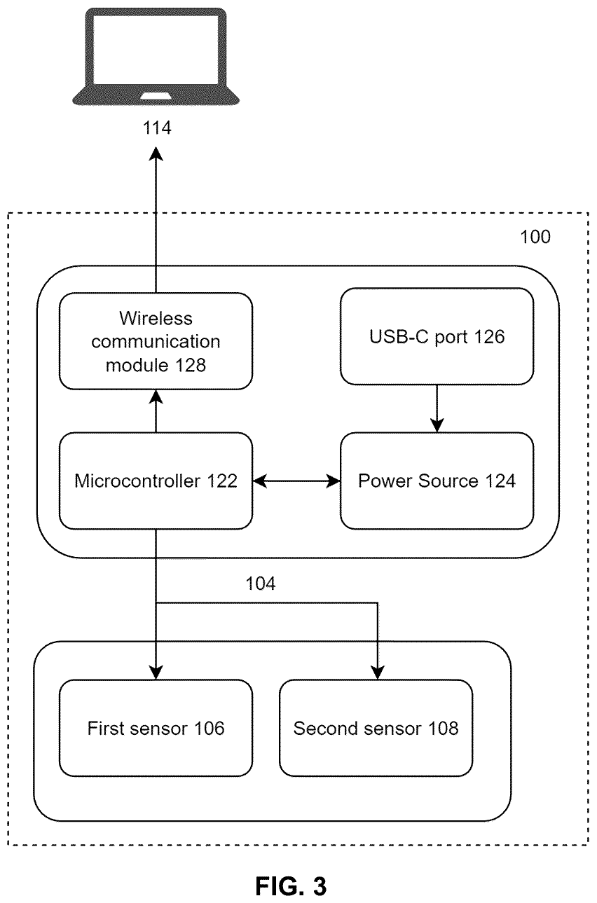

FIG. 3 presents a block diagram illustrating the components of the wearable device and their interactions, including both hardware and software elements. This figure provides a comprehensive overview of the internal structure of the device and its connection to an external device, such as a laptop.

At the core of the wearable device is the control module, which in the present example is a microcontroller unit (MCU) 122, responsible for processing signals and executing commands. The MCU 122 is electrically connected to the power source 124, which, in this embodiment, is a rechargeable lithium-ion battery. The battery 124 provides power to all components of the wearable device and is rechargeable via a USB-C port 126 also integrated into the wearable unit.

The control module 100 is further connected to the first sensor 106 and the second sensor 108 via the flexible wire 104. The sensors 106 and 108 detect finger movements, such as bending, and send corresponding signals to the MCU 122 for processing.

The sensors may be simple pressure sensors that detect the change in resistance or the like when a user has been their corresponding finger to press them.

In other examples, the MCU 122 may run software modules that include a signal processing module and a gesture recognition module. The signal processing module filters and interprets the raw data received from the sensors 106 and 108, distinguishing between valid gestures and incidental movements. The gesture recognition module then maps the processed signals to specific commands based on predefined thresholds and patterns stored within the module.

Either way, once the device identifies a command, the MCU 122 communicates with the wireless communication module 128. In this embodiment, the wireless communication module 128 is a Bluetooth Low Energy (BLE) module that establishes a wireless connection 130 with an external device 114, here represented as a laptop. The BLE module 128 transmits the control signals generated by the MCU 122 to the laptop 114.

The laptop 114 executes the command received from the wearable device. In the current example, this command corresponds to advancing to the next slide in a presentation application running on the laptop 114. The laptop 114 may also include additional software to manage the connection with the wearable device, ensuring secure and reliable communication.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the device of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A device for wirelessly controlling an external system, comprising:
a wearable unit configured to be worn on a user's wrist, the wearable unit including:
a power source,
a control module electrically connected to the power source, and
a wireless communication module operatively connected to the control module;
at least one sensor operatively connected to the control module, the sensor configured to detect movement of at least one finger of the user's hand;
at least one connecting element configured to operatively connect the sensor to the wearable unit;
wherein the control module is configured to generate a control signal based on the detected movement of the at least one finger, and the wireless communication module is configured to transmit the control signal to the external system.

2. The device of claim 1, wherein the at least one sensor comprises a first sensor configured to be attached to the ring finger of the user's hand and a second sensor configured to be attached to the middle finger of the user's hand.

3. The device of claim 2, wherein the first sensor is configured to detect bending of the ring finger, and the second sensor is configured to detect bending of the middle finger.

4. The device of claim 3, wherein the control module is configured to generate a first control signal in response to the detected bending of the ring finger and a second control signal in response to the detected bending of the middle finger.

5. The device of claim 4, wherein the control module is further configured to distinguish between intentional and unintentional finger movements based on a predetermined threshold of sensor output.

6. The device of claim 5, wherein the predetermined threshold includes a requirement that the bending movement be sustained for a minimum duration before the control module generates the control signal.

7. The device of claim 1, wherein the at least one connecting element comprises a flexible wire extending from the wearable unit to the at least one sensor.

8. The device of claim 7, wherein the flexible wire is encased in a protective sheath to enhance durability and prevent damage during movement.

9. The device of claim 1, wherein the wearable unit further comprises a housing made from a stretchable material to accommodate various wrist sizes.

10. The device of claim 9, wherein the wearable unit includes an adjustable strap configured to secure the wearable unit to the user's wrist.

11. The device of claim 1, wherein the wireless communication module comprises a Bluetooth Low Energy (BLE) module configured to transmit the control signal to the external system.

12. The device of claim 11, wherein the wireless communication module is configured to establish and maintain a secure connection with the external system using adaptive frequency hopping to minimize interference.

13. The device of claim 1, wherein the power source comprises a rechargeable battery integrated into the wearable unit.

14. The device of claim 13, wherein the rechargeable battery is configured to be recharged via a USB-C port integrated into the wearable unit.

15. The device of claim 13, wherein the wearable unit further comprises a power management system configured to conserve battery life by entering a low-power mode when the device is not in use.

16. The device of claim 1, wherein the control module is further configured to provide haptic feedback to the user upon detection of a valid control signal.

17. The device of claim 1, wherein the control module is configured to allow user calibration of the sensor sensitivity to accommodate different finger movement characteristics.

18. The device of claim 1, further comprising a feedback mechanism on the wearable unit, the feedback mechanism including at least one of an LED indicator or a sound emitter, configured to notify the user of the operational status of the device.

19. The device of claim 1, wherein the external system is a computer, and the control signal is configured to control a software application running on the computer.

20. The device of claim 19, wherein the software application is a presentation software, and the control signals are configured to navigate between slides in the presentation.
